(19) United States
(12) Patent Application Publication
(10) Pub. No.: US 2012/0046485 A1
(43) Pub. Date: Feb. 23, 2012

(54) Novel Polyorganosiloxanes And Use Thereof

(75) Inventors: Dieter Wrobel, Leverkusen (DE); Hubertus Eversheim, Wermelskirchen (DE); Julien Richeton, Frankfurt am Main (DE)

(73) Assignee: MOMENTIVE PERFORMANCE MATERIALS GMBH, Leverkusen (DE)

(21) Appl. No.: 13/255,257

(22) PCT Filed: Mar. 12, 2010
(86) PCT No.: PCT/EP2010/053180

§ 371 Date: Nov. 14, 2011

(30) Foreign Application Priority Data
Mar. 13, 2009 (DE) 10 2009 012 655.1

(51) Int. Cl. C07F 7/08; F16F 13/00; F28F 7/00

(52) U.S. Cl. 556/450; 165/185; 267/140.11

(57) ABSTRACT

The invention relates to novel polyorganosiloxanes, methods for their preparation and their use, in particular as force and/or heat transmitting liquids, such as hydraulic liquids, and in cosmetic compositions.

The invention relates to novel polyorganosiloxanes, methods for their preparation and their use, in particular as force and/or heat transmitting liquids, such as hydraulic liquids.

Apart from various aliphatic, aromatic or unsaturated hydrocarbons, such as alpha olefins, phosphoric acid esters, phenylethers, polyesters or polyethers, polyorganosiloxanes have long been known as synthetic hydraulic liquids (e.g. U.S. Pat. No. 2,398,187; U.S. Pat. No. 4,048,084; U.S. Pat. No. 4,116,847; U.S. Pat. No. 4,132,664; U.S. Pat. No. 4,175,049; U.S. Pat. No. 4,357,473; GB 1093555; GB 867167; U.S. Pat. No. 4,340,495 etc). Furthermore, U.S. Pat. No. 5,684,112 discloses branched polyorganosiloxanes as conditioners for use in cosmetic compositions. A compound of the formula (Me₃SiO)₃Si-phenyl is sold by Momentive Performance Materials under the brand name Baysilon PD5 as a damping liquid, among other things. In case of contact with silicone seals or membranes, however, the above compound, like many other polyorganosiloxanes with a low molar weight, leads to an increased swelling of the silicone seals or membranes or to a diffusion of the liquid through the silicone seal and thus to the liquid leaking out. Thus, the object of the present invention was to find a medium which is suitable as a force-transmitting liquid and does not exhibit the aforementioned drawbacks. The medium was to be capable, in particular, of being used for force transmission, as well as a medium for damping, i.e. delayed force distribution or force transmission. This requirement is evident particularly in a hydro-mount which is comprised of elastic rubber membranes as a spring system or of air cushions enclosed by membranes which separate another space with a viscous, damping force-transmitting liquid. Moreover, this liquid was supposed to have a suitable viscosity range at various temperatures, in particular at low temperatures, as well as be resistant to high temperatures and modify the enclosing membrane only to a small extent. Furthermore, the liquid medium was supposed to have a low compressibility and, during interaction with metals and sealing materials, such as, in particular, elastomers, such as silicone elastomers, should not change their properties if possible.

Though the glycols that are also used as damping liquids in the production of so-called hydro-mounts can be used in hydro-mounts with elastomeric spring elements based on natural rubber or EPDM, they prove to be largely unfit for use in the case of spring elements from silicone elastomers because, though they lead to an acceptable swelling, they cause an undesirably high degree of diffusion or permeability or permeation through these membranes, and furthermore do not have a sufficiently low viscosity in the low-temperature range. Other compounds, such as low-molecular synthetic media, have a boiling point that is too low, or they resinify in the presence of atmospheric oxygen or humidity in such a way that the viscosity at least increases or that the liquid actually solidifies.

Therefore, the invention had the object of finding a suitable liquid that avoids these problems that occur in the case of contact of glycols, hydrocarbons or linear polydimethylsiloxanes with polyorganosiloxane elastomer membranes or seals.

In the class of silylated siliconates and silicates, the inventors surprisingly found compounds with a low degree of polymerization that were capable of achieving these objects.

Hence, the present invention provides:

The use of polyorganosiloxanes of the formula (I):

MₐD_{b}T_{c}Q_{d} (I)
wherein:
a=2 to 6, preferably 3 or 4, particularly preferably 4,
b=0 to 10, preferably 0 to 2, still more preferably 0,
c=0 to 3, preferably 0 to 2, more preferably 0 or 1,
d=0 to 2, preferably 0 or 1,
c+d=1 to 2, preferably 1,
a/(c+d)>2, preferably ≧3,
wherein
M, D, T, Q signify

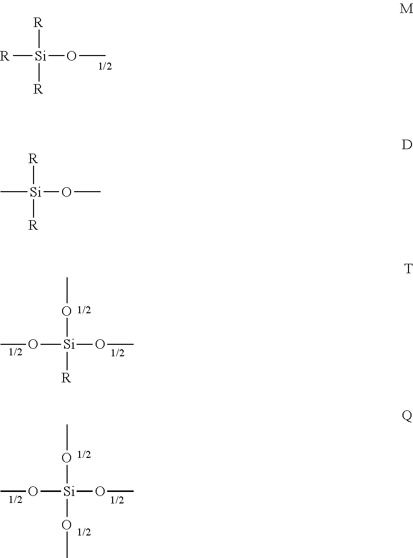

and
R is selected from the group consisting of:
aliphatic and/or aromatic residues with up to 30 carbon atoms which can comprise one or more oxygen atoms, one or more halogen atoms as well as one or more cyano groups, provided that
at least one of the residues R in M is bonded to silicon via a carbon atom and at least one of the residues R in M comprises at least 2, preferably at least 4, still more preferably at least 5 carbon atoms,
   wherein they
are used as force and/or heat transmitting liquid or as a constituent in cosmetic compositions.

A force-transmitting liquid is suitable for transmitting and/or distributing mechanical forces over a certain distance between the location of generation and the location of action. In particular, hydraulic, damping and gear liquids or oils count among force-transmitting liquids. Requirements that are met by the force-transmitting liquids according to the invention generally include:
good lubrication properties
high resistance to ageing
high flash point,
low setting point or pour point,
compatibility with silicone elastomers,
in particular low permeability or permeation,
freedom from resins or acids,
low influence of temperature on viscosity (both dynamic as well as kinematic viscosity)
low compressibility.

Thus, the polyorganosiloxanes of the formula (I) preferably have a pour point (DIN ISO 3016, ASTM D5985) of less than −28° C. or a setting point (DIN ISO 3016, ASTM E 537-76 D of less than −30° C.

The polyorganosiloxanes of the formula (I) preferably have a boiling point of greater than 180° C., preferably of greater than 190° C.

The polyorganosiloxanes of the formula (I) preferably have a permeation on polydimethylsiloxane elastomers, determined as so-called fuel permeability FP in accordance with DIN 53532, of less than 70 [g/m²/d] at 140° C., preferably less than 40 [g/m²/d], particularly preferably an FP value of less than 20 [g/m²/d] for a sample having a thickness of 2 mm.

In formula (I), groups R both include groups R which are bonded via carbon atoms to silicon atoms as well as groups R which are bonded via oxygen atoms to silicon atoms, i.e., they are in this case alkoxy groups (hereinafter sometimes referred to as R′).

Polyorganosiloxanes according to the invention with groups M that comprise alkoxy groups R′ are, however, less preferred, or, in other words: Si—C-bonded groups R (hereinafter sometimes referred to as R″) in M are preferred according to the invention.

The requirement according to which at least one of the residues R in M is bonded to silicon via a carbon atom and at least one of the residues R in M comprises at least two carbon atoms also includes the case that there is a residue R present in M which is Si—C-bonded and at the same time comprises at least two carbon atoms, preferably at least four carbon atoms, still more preferably at least five carbon atoms. This case, in which M comprises an Si—C-bonded residue R with at least two carbon atoms, preferably at least four carbon atoms, still more preferably at least five carbon atoms, is the case preferred in the invention.

In a preferred embodiment, at least one of the residues R in M in the polyorganosiloxanes according to the invention represents a group which comprises an aromatic group, in particular a phenyl group, preferably a phenylethyl or phenylpropyl group, in particular a (2-phenyl-2-methyl)-ethane-1-yl group.

In a preferred embodiment, at least one of the residues R in M in the polyorganosiloxanes according to the invention represents a group of the formula R* which is selected from the group consisting of:
aryl,
—CH₂—CHR¹—R², wherein
R¹ is hydrogen or C₁ to C₃-alkyl, and
R² has the same meaning as R,
—CR³═CH—R²,
wherein
R² has the same meaning as R, and
R³ has the same meaning as R or is hydrogen.

Preferred groups M include:
—SiR″₃;

wherein preferably at least one, more preferably exactly one group R″ is a group R*, as mentioned above; particularly preferably, M is a group
SiMe₂R*;
   or
—SiR″₂R′;
wherein at least one of the residues R″ or R′ comprises at least two carbon atoms, preferably at least four carbon atoms, still more preferably at least five carbon atoms; particularly preferably, M is
SiMe₂R′.

The polyorganosiloxanes according to the invention can comprise the same or different groups M. That means that, apart from the obligatory groups M as defined above, there may also be groups M present that neither comprise residues R with at least two carbon atoms, nor SiC-bonded residues, such as —SiMe₃ and —Si(OMe)₃.

Preferably, however, all groups M in the polyorganosiloxanes according to the invention comprise residues R with at least two carbon atoms, in particular SiC-bonded residues R with at least two carbon atoms.

In another preferred embodiment, the present invention relates to the use of polyorganosiloxanes of the formula (I), wherein the polyorganosiloxanes have the formula (Ia) or (Ib):

M₂₋₆Q₁₋₂ (Ia),

M₂₋₆D₀₋₃T₁₋₂ (Ib),

wherein M, D, T and Q are as defined above.

Preferably, the polyorganosiloxanes of the formulae (Ia) or (Ib) have the following structures:

M₄Q,

M₃T.

In another preferred embodiment, the present invention relates to the use of polyorganosiloxanes of the formula (I), wherein all residues M comprise at least one, preferably exactly one group of the formula R*.

In another preferred embodiment, the present invention relates to the use of polyorganosiloxanes of the formula (I), wherein all residues R in M are bonded via carbon atoms to silicon.

Most preferably, the polyorganosiloxanes according to the invention comprise identical groups M comprising SiC-bonded residues R with at least two carbon atoms, in particular R*.

Examples include:

QM₄,

such as, for example:

SiO—SiR″_{3-z}—R*_{z}]₄z=1-2

SiO—SiR″_{3-z}—R′_{z}]₄z=1-2

preferred are the formulae

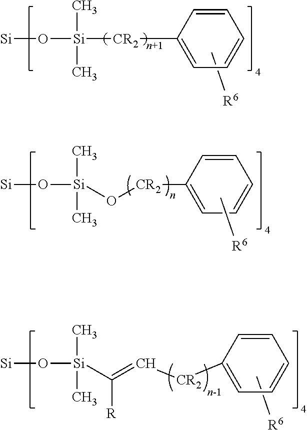

or compounds of the type TM₃,
such as, for example:

R⁵Si—O—SiR″_{3-z}—R*_{z}]₃z=1-2

R⁵Si—O—SiR″_{3-z}—R′_{z}]₃z=1-2

preferred are the formulae:

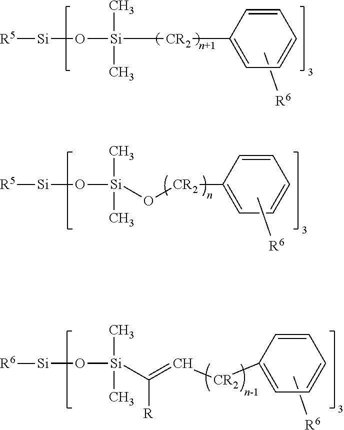

n=0 to 8, preferably 1 to 5.

In a preferred embodiment, the present invention relates to the use of polyorganosiloxanes of the formula (I), wherein the ratio of the siloxane units is M:Q=4 to 1:1, preferably 4 to 3:1, or M:T=3 to 1:1, preferably 3 to 2:1.

In another preferred embodiment, the present invention relates to the use of polyorganosiloxanes of the following formulae:

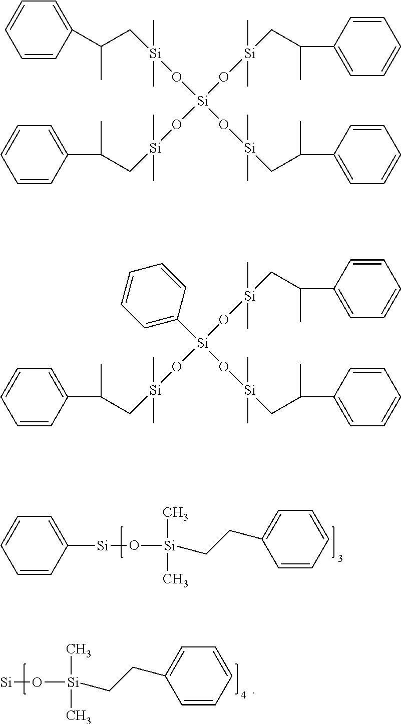

In another preferred embodiment, the present invention relates to the use of polyorganosiloxanes of the formula (I), which have a viscosity of less than 100 mPa·s at 25° C. and a shear rate gradient of D=1 s⁻¹. I.e., the polyorganosiloxanes of the formula (I) are generally liquid at room temperature. Preferably, the polyorganosiloxanes according to the invention are still liquid even at −40° C., and at −40° C. in particular have a viscosity of less than 20,000 mPa·s, preferably measured at a shear rate D of 1 s⁻¹.

Preferably, the polyorganosiloxanes used according to the invention have a molecular weight (determined by gel permeation chromatography against polystyrene as standard) with a number average Mₙ of 360 to 2,000 g/mol.

The use according to the invention in particular includes the use as a force-transmitting liquid in hydro-mounts. Hydro-mounts are damping elements comprising a spring body and a damping unit. The damping unit comprises the cavities and flow channels filled with the force-transmitting liquid (see e.g. EP 0 547 287). Accordingly, the present invention also relates to hydro-mounts comprising polyorganosiloxanes of the formula (I).

Moreover, the polyorganosiloxanes of the formula (I) surprisingly can also be used as a constituent of cosmetic compositions, because siloxane compounds with a solubility behavior suitable for cosmetic ingredients can be provided therewith. Furthermore, they have a desired low spreading or migration behavior, low stickiness with regard to, for example, sand and dust, and a high refractive index n₂₅^{D} of more than 1.50, in particular higher than 1.51. A refractive index of more than 1.51 was found in particular in compounds of the formula (Ia) and (Ib) and R═ arylalkyl. Special glossy effects can be accomplished therewith. In addition, the low migration behavior is desired in particular in coloring cosmetic formulations in order to prevent these components from entering the eye or mouth. There, they act in particular as film-forming agents, glossing additives, enhancers for making the constituents compatible, carrier material for sun blocking products, in particular in water-resistant sun-blocking products that have a low sand adhesion (‘anti-sanding’), as glossing constitutents, in particular of decorative skin-care products, such as lipsticks, make-up by means of the properties of the polyorganosiloxanes of the formula (I), which in contrast to fats, oils, such as in particular polydimethylsiloxanes, spread to a lesser extent. Thus, cosmetic compositions such as mascaras and ‘lip gloss’, other coloring skin-care products as well as hair care products such as shampoos, conditioners and in particular hair tonics, oils and fluids for enhancing the gloss of skin, nail and hair surfaces can advantageously be produced with the compounds according to the invention. Due to the high refractive index of more than 1.5, the substances according to the invention are also eminently suitable to contribute to reducing the whitening of pigmented or solid-containing or wax-containing cosmetic products (antitranspirants) on the skin (‘anti-whitening’).

Accordingly, the present invention also relates to cosmetic compositions comprising polyorganosiloxanes of the formula (I).

The polyorganosiloxanes according to the invention also include novel compounds of the formula (I′):

MₐD_{b}T_{c}Q_{d} (I′)
wherein:
a=2 to 6, preferably 2 to 4
b=0 to 2, preferably 0
c=0 to 2, preferably 0 or 1,
d=0 to 2, preferably 0 or 1,
c+d=1 to 2,
a/(c+d)>2
wherein
M, D, T, Q signify

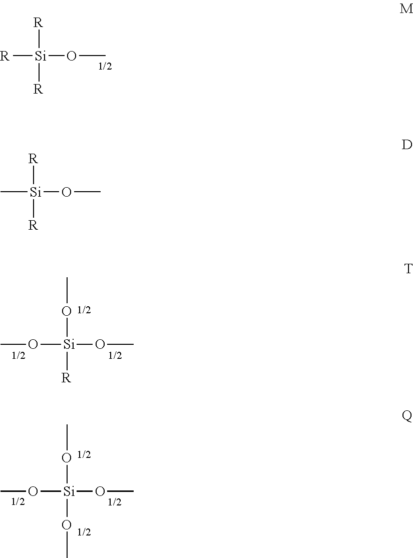

and wherein
R is selected from the group consisting of:
aliphatic and/or aromatic residues with up to 30 carbon atoms which can comprise one or more oxygen atoms, one or more halogen atoms as well as one or more cyano groups,
provided that at least one of the residues R in M is bonded to silicon via a carbon atom and at least one of the residues is arylalkyl or arylalkenyl. With regard to the preferred polyorganosiloxanes of the formula (I′), reference can be made to the comments regarding the polyorganosiloxanes of the formula (I).

Finally, the present invention also relates to a method for preparing polyorganosiloxanes of the formula (I′) comprising
i. reacting a compound of the formula:

M^{H}ₐD_{b}T_{c}Q_{d} (II)
wherein a, b, c, d are as defined above, wherein M^{H}, D, T, Q signify

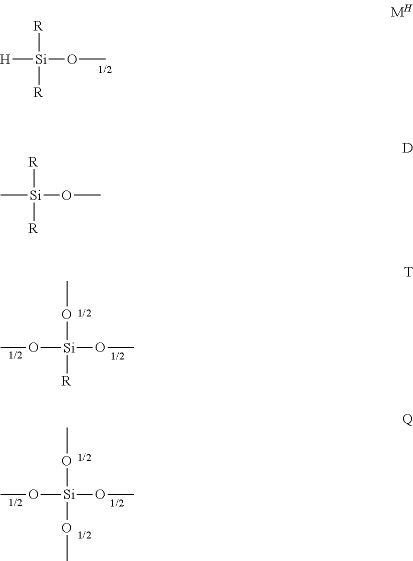

and R is as defined above,
with a compound
CH₂═CHR¹—R², wherein R¹ and R² are as defined above, or with a compound
CR³≡CR², wherein R² and R³ are as defined above, in the presence of a hydrosilylation catalyst, or
ii. reacting a compound of the formula:

M^{H}ₐD_{b}T_{c}Q_{d} (II)
which is as defined above,
with a compound of the formula HO—R, wherein R is as defined above, in the presence of a catalyst, during which reaction a R—O—Si group is formed in M with hydrogen evolution,
or
iii. hydrolysis or alcoholysis of several halogen and/or alkoxysilanes which correspond to precursors of the units M, D, T, Q as in claim 1, and which comprise at least one group R, wherein R is as defined above.

The invention is illustrated in more detail by the following examples.

### EXAMPLES

### Example 1

### Preparation of Si[OSiMe₂H]₄ and its Oligomers

2,010 g tetramethyldisiloxane (30 mol), 1,200 g water, 60 g 37% hydrochloric acid and 1,000 g toluene are received under nitrogen blanketing in a 61 flat flange vessel with a heating or cooling jacket equipped with a stirrer, thermometer, reflux condenser and dosing device. 1,248 g tetraethoxysilane (6 mol) is metered in under vigorous stirring. Due to the reaction, the mixture heats up to 47° C. during metering.

After the metering process is completed, this is followed by stirring for one hour; after the stirrer has been switched off, 2 phases form rapidly; the lower aqueous phase is separated and discarded, the top organic phase is washed with 100 ml water. After the aqueous phase has been removed, the excess tetramethyldisiloxane is separated in a fractioned manner by single-stage distillation with a column. The distillation process is stopped as soon as an overhead temperature of 110° C. has been reached.

Analysis of the remaining bottom by gas chromatography yielded a composition of 71% by wt. QM^{H}₄, 3.3% Q₂M^{H}₆ 1% Q₃M^{H}₈ and 24.7% Toluene with an SiH content of 9.15 mmol/g. This fraction was added without further purification to the subsequent reaction of Example 2, in which the olefin was attached to the SiH bond.

### Example 2

### Preparation of a polyorganosiloxane of the Formula Si[OSiMe₂R*]₄ tetrakis(dimethylphenylpropylsiloxy)silane

3,835 g α-methylstyrene CH₂═CHCH₃—C₆H₅ (32.5 mol), 710 g product from Example 1 (6.5 mol M^{H}) are received under nitrogen blanketing in a 6 l flat flange vessel with a heating or cooling jacket equipped with a stirrer, thermometer, reflux condenser and dosing device, and heated to 90° C. with stirring. 0.44 g Pt of a platinum catalyst consisting of a Pt⁰ complex in tetramethyltetravinylcyclotetrasiloxane (Silopren catalyst Pt/S) with a Pt content of 15% by wt. is added to the mixture.

The mixture heats up to 120° C. due to the released reaction heat. The rest of the amount of 2,022 g reaction mixture from Example 1 (18.5 mol M^{H}-groups) is metered in within approximately one hour. The temperature of the reaction mixture is kept between 140 and 150° C. by controlling the metering rate or by controlling the temperature of the heating means.

After the metering process was completed, this was followed by stirring for 3 hours at 140° C. The subsequent measurement of the SiH content yields 0.03 mmol/g. This corresponds to a conversion relative to SiH of 99.2%. The excess methylstyrene is removed by baking out at 150° C. bottom temperature and a vacuum of <5 mbar. After cooling off to below 100° C., the platinum catalyst is removed by adding 25 g activated carbon Prekolit BKT 3 and 5 g water, followed by stirring for one hour, and removing the water under vacuum at 60° C. and a pressure of <30 mbar. After the further addition of 30 g diatomaceous earth Celite 499, the product is filtered through a Seitz pressure nutsche covered with a filter layer of Supra 300.

Yield: 5,114 g of a slightly yellow-colored product=90% relative to the SiH siloxane used.

Characteristic Data of the Product:

Formula:

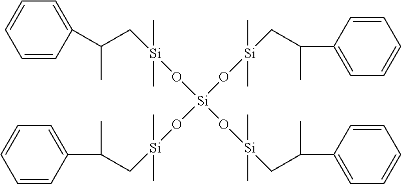

Viscosity at 25° C. in a Happier falling-ball viscometer: 40 mPa·s at 25° C., 4,117 mPa·s at −40° C.,

Refractive index n₂₅^{D}=1.5020, density: 25° C. by aerometer 1.015 g/ml.

Evaporable contents determined with the Mettler HR 73 halogen dryer, 1 g weighed portion after 30 min 120° C. of 1.6% by wt.

### Example 3

### Preparation of the Precursor T^{Ph}M^{H}₃

2,010 g tetramethyldisiloxane (30 mol), 1,200 g water, 60 g 37% hydrochloric acid and 1,000 g toluene are received in a 61 flat flange vessel with a heating/cooling jacket equipped with a stirrer, thermometer, reflux condenser, dosing device and nitrogen blanketing. 1,586 g phenyltrimethoxysilane (8 mol) are metered in with vigorous stirring. Due to the reaction, the reaction mixture heats up to 47° C. during metering.

After the metering process is completed, this is followed by stirring for one hour; after the stirrer has been switched off, 2 phases form rapidly. The lower aqueous phase is separated and discarded. The top organic phase is washed with 100 ml water. After the aqueous phase has been removed, the excess tetramethyldisiloxane is separated in a fractioned manner by distillation. The distillation process is stopped as soon as an overhead temperature of 110° C. has been reached.

Analysis of the remaining bottom by gas chromatography yielded a composition of 45% by wt. T^{Ph}M^{H}₄, 21% T^{Ph}₂M^{H}₆, 7.5% T^{Ph}₃M^{H}₈ and 26.5% toluene (SiH content 6.2 mmol/g) and is added without further purification to the subsequent reaction of Example 4.

### Example 4

### Preparation of the methylstyrene Derivative PheSi[OSiMe₂R*]₃

3,068 g α-methylstyrene (26 mol), 806.5 g product from Example 1 (5 mol M^{H}) are received in a 6 l flat flange vessel with a heating/cooling jacket equipped with a stirrer, thermometer, reflux condenser, dosing device and nitrogen blanketing, and heated to 90° C. with stirring. 0.42 g of a platinum catalyst consisting of a Pt⁰ complex in tetramethyltetravinylcyclotetrasiloxane with a Pt content of 15% by wt. is metered into the mixture. The reaction mixture heats up to 120° C. due to the released reaction heat. The rest of the amount of 2,419 g reaction mixture from Example 3 (15 mol M^{H}) is metered in within approximately one hour. The temperature of the reaction mixture is kept between 140 and 150° C. by controlling the metering rate or by controlling the temperature of the heating means.

After the metering process was completed, this was followed by stirring for three hours at 140° C. The measurement of the SiH content yields 0.05 mmol/g. This corresponds to a conversion relative to SiH of 98.4%. The excess methylstyrene is removed by evaporation at 150° C. bottom temperature and a vacuum of <5 mbar. After cooling off to below 100° C., the platinum catalyst is removed by adding 25 g activated carbon Prekolit BKT 3 and 5 g water, followed by stirring for one hour, and evaporating the water under vacuum at 60° C. and a pressure of <30 mbar. After the further addition of 30 g diatomaceous earth Celite 499, the product is filtered through a Seitz pressure nutsche covered with a filter layer of Supra 300.

Yield: 4,328 g of a slightly yellow-colored product=91.5% relative to the SiH siloxane used.

Characteristic Data:

Viscosity at 25° C. in a Höppler falling-ball viscometer: 42 mPa·s,

Viscosity at −40° C. in a Höppler falling-ball viscometer: 11,300 mPa·s,

Refractive index n₂₅^{D}=1.5210, evaporable contents, Mettler HR 73 halogen dryer 1.6% by wt. at 1 g weighed portion after 30 min 120° C., density: 25° C. by aerometer spindle 1.000 g/ml

Formula:

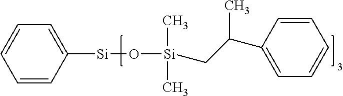

### Example 5

### Measurement of Weight Swelling and Permeabilities on Cross-Linked Silicone Elastomers

In order to test the suitability of the force or heat transmitting liquid according to the invention in contact with silicone elastomers, the degree of swelling and the permeability was investigated in comparison to a standard elastomer of a peroxidically cross-linked highly viscous polydimethylsiloxane rubber, Silopren HV 3/601 by Momentive Performance Materials GmbH

For this purpose, this rubber was cross-linked under pressure for 10 min at 175° C. with 0.6% by wt. Varox. 100%, i.e. 2,5-dimethylhexane-2,5-di-tert.-butylperoxide and was post-crosslinked or tempered for 4 h at 200° C. The following data were determined on a 2 mm testing plate with a surface area of 3.2 10⁻³ m²:

### Measurement of Swelling:

Three testing bodies (triple testing) with a diameter of 36.6 mm are respectively cut out with a punching iron from a 2 mm testing plate of the cross-linked silicone elastomer, and markings for differentiating the samples 1-3 are applied by punching additional small holes.

The weight of each test object is determined on an analytical scale and its density is determined by measuring buoyancy in water with a scale for determining the density. The testing bodies are covered with a liquid level of 10-20 mm. The liquid volume is about 80 times that of the entire testing body volume.

After the contact time with the liquid testing media and defined temperature, the testing bodies are removed and left to cool off to room temperature (25° C.) for about 10 minutes on a cellulose pad. The weight and density are determined again before an hour after removal has passed.

In the process, the weight swelling was calculated according to the following formula.

Weight swelling is calculated in % by: (wt._{before}−wt._{after})*100/wt._{before}

A compound of the composition T^{phe}M₃ (PD5) was additionally provided for the measurements. It had the following characteristics:

Viscosity etaₖᵢₙ=4 cSt or [mm²/s] (20° C.); settling point −102° C., boiling point 110° C. at 1 mm Hg (Torr), density 0.924 g/ml (20° C.), n_{D}²⁰=1.437.

TABLE 1

| Contact medium | Swelling [% by wt.] | Time [h] |
|---|---|---|
| diethyleneglycol | 2 | 96 |
| T^{phe}M₃ | 101 | 96 |
| MD^{alc} M )¹ | 12 | 46 |
| Mineral oil )² | 91 | 46 |
| Example 4 | 9 | 72 |
| Example 2 | 11 | 96 |

)¹ Alc = C₈-alkyl residue (such as Silsoft 034 INCI: caprylyl methicone)
)² Sigma Aldrich order number 33.077-9 n₂₀^{D} = 1.4680 D = 0.838 [g/ml]. The experiment shows that the polyorganosiloxanes used according to the invention exhibit a slightly increased weight swelling compared with glycol. However, swelling is less than that of mineral oil or a compound such as T^{phe}M₃.

### Determination of Permeability:

Permeability was determined as a FP value according to the formula in DIN 53532 with aluminum testers by Rycobel, hereinafter referred to as “vapometer”. The testing surface of the respective individual samples of the cross-linked silicone elastomer was 31.7 cm², thickness was about 2 mm, the duration of the experiment was 42 days.

Following a defined preconditioning of the testing bodies from silicone elastomer in a climate chamber at 23° C. and 50% air humidity over 12 h, the testing body plates with the above-mentioned dimensions were attached to one vapometer, respectively, and the latter were placed for the measurement in a circulating drying cabinet at the specified temperatures—in this case 140° C.—and storage times. After the measurement, the vapometer was removed from the circulating cabinet heated to 140° C. The testing bodies of silicone elastomer were left to cool off for 1 h in a climate chamber at 23° C. and 50% air humidity, and the weight change of the testing bodies was determined.

The calculation was carried out in accordance with the formula specified in DIN 53532, with no additional corrections being made.

FP=k.10⁴/A in [g(m²/d]

with simplified k=(m₀−mₜ)/(t−t₀), i.e. k corresponds to the gradient of a straight line in the mass-time diagram.

A=surface area in [cm²], m₀=initial mass in [g] at starting time t₀,

m=mass after contact after testing time t in [days] or [d]

TABLE 2

| | Permeability FP at 140° C. |
|---|---|
| | [g/m²/d] |
| glycol | 152 )³ |
| Example 4 | 14.8 |
| Example 2 | 13.4 |
| MD^{alk} M )¹ | >1500 )⁴ |

)¹ Silsoft ® 034 by Momentive
)³ the vapometer did not contain any more liquid after 14 days, i.e. diffusion was too high for determining a quantity flow.
)⁴ the vapometer did not contain any more liquid after 2 days, i.e. diffusion was too high for determining a quantity flow.

The experiments show that permeability, measured as FP value at 140° C., is smaller with the polyorganosiloxanes used according to the invention than in contact with glycol or a siloxane of the formula T^{phe}M₃, which has a similar structure as Example 4, in which, however, M signifies Me₃SiO_{1/2}—. This is surprising because the person skilled in the art, due to the higher swelling as compared to glycol, would have expected a higher permeability value FP also for the compounds according to the invention, such as it can typically measured, for example, in the case of the compound T^{phe}M₃.

### Example 6

The use of the compounds according to the invention and their suitability in cosmetic formulations is illustrated with the following compositions:

Water-Resistant Mascara Composition with a polymethyl siloxane Resin of the MQ type, such as SR 1000

| | | Brand name | |
|---|---|---|---|
| | | by Momentive | |
| wt-% | INCI | or Example | Function |
| 5.0 | Cyclopentasiloxane (and) | SF 1540 | emulsifier |
| | PEG/PPG-20/15 dimethicone | | |
| 7.5 | Dimethicone (and) | TP 3784 | film-forming |
| | isododecane | | agent |
| 1.6 | Cetyl Alcohol | | |
| 1.6 | | Example 2 | film-forming |
| | | | agent |
| 1.6 | Trimethylsiloxysilicate | SR 1000 | adhesion |
| | | | extender |
| 4.6 | Carnauba wax | | wax |
| 4.65 | Bees wax | | wax |
| 3.0 | Stearic acid | | |
| 2.0 | Polymethylsilsesquioxane | Tospearl ® | skin-feeling |
| | | 2000 B* | enhancer |
| 1.2 | Triethanolamine | | pH regulator |
| 57.0 | Aqua | | liquid carrier |
| 0.75 | Hydroxyethylcellulose | | thickening |
| | | | agent |
| 9.5 | Pigments | | pigments |

### Example 7

Cosmetic Formulation: Mascara Containing a So-Called “fluorosilicate” (INCI) with Extended Adhesion Time

| | | | |
|---|---|---|---|
| | | Brand name | |
| % by | | by Momentive | |
| wt. | INCI | or Example | Function |

component A

| | | | |
|---|---|---|---|
| 1.5 | Cetyl alcohol | | wax |
| 2.0 | Stearic acid | | wax |
| 4.0 | Carnauba wax | | wax |
| 5.5 | C₃₀-C₄₅-alkyl dimethicone | SF 1642 | wax |
| 2.0 | Trifluoropropyldimethylsiloxy- | XS66 B8226 | adhesion |
| | trimethylsiloxysilicate | | extender |
| 6.0 | Cyclopentasiloxane | SF 1202 | solvent |
| 2.0 | | Example 4 | film-forming |
| | | | agent |

component B

| | | |
|---|---|---|
| 63.55 | Aqua | solvent |
| 0.25 | Hydroxyethylcellulose | thickening |
| | | agent |
| 2.0 | Polyvinylpyrrolidone | film-forming |
| | | agent |
| 1.2 | Triethanolamine | pH regulator |

component C

| | | |
|---|---|---|
| 10.0 | Pigments | pigments |

### Example 8

Cosmetic Formulation: “Cream-To-Powder” Make-Up

| | | Brand name | |
|---|---|---|---|
| % by | | by Momentive | |
| wt. | INCI | or Example | Function |
| 44.5 | Cyclopentasiloxane (and) | Velvesil ® 125 | Skin-feeling- |
| | C₃₀-C₄₅-alkyl cetearyl | | enhancer/matting |
| | dimethicone crosspolymer | | agent |
| 30.5 | Cyclopentasiloxane | SF 1202 | solvent |
| 3.0 | | Example 2 | compatibility |
| | | | enhancer |
| 6.5 | Cyclopentasiloxane (and) | SF 1214 | liquid carrier - |
| | dimethicone | | solvent |
| 12.0 | Polymethyl- | Tospearl ® | soft-feel additive |
| | silsesquioxane | 2000 B | |
| 3.5 | | pigments | pigment |

### Example 9

Cosmetic Formulation: Wax-Like Lip-Gloss Formulation

| | | | |
|---|---|---|---|
| | | Brand name | |
| % by | | by Momentive | |
| wt. | INCI | or Example | Function |

component A

| | | | |
|---|---|---|---|
| 75.0 | Caprylic/capric | | |
| | triglyceride | | |
| 20.0 | PEG bees wax | | wax |
| 2.0 | | Example 4 | glossing additive |

component B

| | | | |
|---|---|---|---|
| 3.0 | Cyclopentasiloxane | SF 1202 | evaporable liquid |
| | | | carrier |

### Example 10

Cosmetic Formulation: Liquid Color Lipstick

| | | Brand name | |
|---|---|---|---|
| % by | | by Momentive | |
| wt. | INCI | or Example | Function |
| 12.0 | Dimethicone (and) | TP 3784 | liquid carrier - |
| | isododecane | | solvent |
| 9.5 | Isododecane (&) disteardi- | Bentone gel | |
| | monium hectorite (&) | | |
| | propylene carbonate | | |
| 23.0 | | | pigments |
| 12.5 | Trimethylsiloxysilicate | SR 1000 | adhesion extender |
| 26.0 | Ethyltrisiloxane | Silsoft ® ETS | evaporable liquid |
| | | | carrier |
| 10.0 | C₃₀-C₄₅-alkyl dimethicone | SF 1642 | wax |
| 4.5 | | Ceralution H | |
| 2.5 | | Example 4 | film-forming |
| | | | agent |

### Example 11

Cosmetic Formulation: Liquid Lipstick

| | | Brand name | |
|---|---|---|---|
| % by | | by Momentive | |
| wt. | INCI | or Example | Function |
| 10.0 | Dimethicone (and) isododecane | Baysilone ® | liquid carrier - |
| | | TP 3784 | solvent |
| 9.5 | Isododecane (and) | | |
| | disteardimonium hectorite | | |
| | (and) propylene carbonate | | |
| 12.0 | C₃₀-C₄₅-alkyl dimethicone | SF 1642 | wax |
| 12.0 | Trimethoxysiloxysilicate (and) | TP 3744 | adhesion |
| | isododecane | | extender |
| 4.5 | Behenyl alcohol & glyceryl | | |
| | stearate & glyceryl stearate | | |
| | citrate & sodium dicocoylethyl- | | |
| | enediamine PEG-15 sulfate | | |
| 2.5 | | Example 2 | film-forming |
| | | | agent |
| 25.5 | Isododecane | | liquid carrier |
| 24.0 | pigments | | pigment |

### Example 12

Lipstick Composition with Pigments

| | | Brand name | |
|---|---|---|---|
| % by | | by Momentive | |
| wt. | INCI | or Example | Function |
| 12 | Dimethicone (and) isododecane | TP 3784 | liquid carrier - |
| | | | solvent |
| 9 | Bentone gel ISDV | | |
| 12 | Trimethoxysiloxysilicate (and) | TP 3744 | adhesion |
| | isododecane | | extender |
| 11 | C30-C45-alkyl dimethicone | SF 1642 | wax |
| 5 | Ceralution H | Ceralution H | |
| 2.4 | | Example 2 | film-forming |
| | | | agent |
| 10 | Carnauba wax LT 314 | carnauba | wax |
| | | wax LT 314 | |
| — | | SF 1632 | |
| 15.6 | Isododecane | isododecane | solvent |
| 14.86 | Corona Bordeaux | | pigment |
| 8.14 | Timiron Sun Gold Sparkle | | pigment |
| | MP-29 | | |

Examples 6 to 12 show that compounds such as those of Examples 2 and 4 can replace cosmetic ingredients, such as the compound Silshine® 151 listed under the INCI name phenylpropyldimethylsiloxysilicate, with regard to miscibility with cosmetic ingredients without having to accept evident drawbacks with respect to the cosmetic properties. The high refractive index of the compound from Example 4 leads to particularly advantageous glossy effects.

1-17. (canceled)

18. Polyorganosiloxanes of the formula (I):
MₐD_{b}T_{c}Q_{d}
wherein:
a=2 to 6,
b=0 to 10,
c=0 to 3,
d=0 to 2,
c+d=1 to 2,
a/(c+d)>2
wherein M, D, T, Q signify 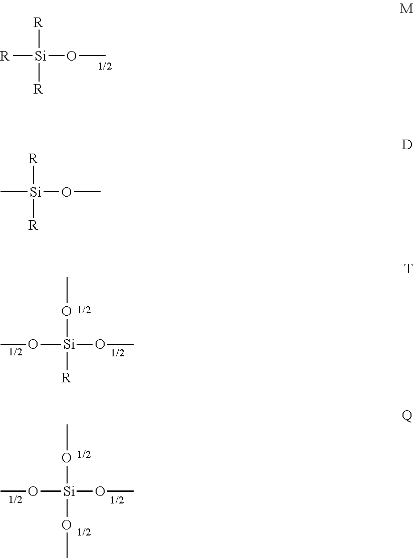
and
R is selected from the group consisting of:
aliphatic and/or aromatic residues with up to 30 carbon atoms which can comprise one or more oxygen atoms, one or more halogen atoms as well as one or more cyano groups, provided that at least one of the residues R in M is bonded to silicon via a carbon atom and at least one of the residues R in M comprises at least two carbon atoms.

19. The polyorganosiloxanes according to claim 18, wherein at least one of the residues R in M represents a group of the formula R* which is selected from the group consisting of:
aryl,
—CH₂—CHR¹—R², wherein
R¹ is hydrogen or C₁ to C₃-alkyl, and
R² has the same meaning as R,
CR³═CH—R², wherein
R² has the same meaning as R, and
R³ has the same meaning as R or is hydrogen.

20. The polyorganosiloxanes according to claim 18, wherein the polyorganosiloxanes have the formulae (Ia) or (Ib):
M₂₋₆Q₁₋₂ (Ia)
M₂₋₆D₀₋₃T₁₋₂ (Ib).

21. The polyorganosiloxanes according to claim 19, wherein the polyorganosiloxanes have the formulae (Ia) or (Ib):
M₂₋₆Q₁₋₂ (Ia)
M₂₋₆D₀₋₃T₁₋₂ (Ib).

22. The polyorganosiloxanes according to claim 18, wherein the ratio of the siloxane units is M:Q=4 to 1:1 or M:T=3 to 1:1.

23. The polyorganosiloxanes according to claim 19, wherein the ratio of the siloxane units is M:Q=4 to 1:1 or M:T=3 to 1:1.

24. The polyorganosiloxanes according to claim 20, wherein the ratio of the siloxane units is M:Q=4 to 1:1 or M:T=3 to 1:1.

25. The polyorganosiloxanes according to claim 20, wherein the polyorganosiloxanes of the formulae (Ia) and (Ib) have the following structure:
M₄Q (Ia),
M₃T (Ib).

26. The polyorganosiloxanes according to claim 19, wherein all the residues M comprise at least one group of the formula R*.

27. The polyorganosiloxanes according to claim 18, wherein all the residues M comprise exactly one group of the formula R*.

28. The polyorganosiloxanes according to claim 18, wherein all the residues R in M are bonded to silicon via carbon atoms.

29. The polyorganosiloxanes according to claim 18, wherein the polyorganosiloxanes are selected from the group consisting of:

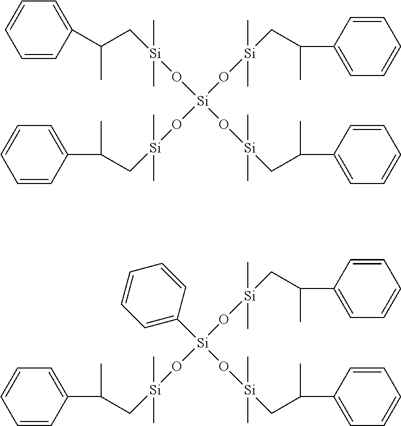

30. The polyorganosiloxanes according to claim 18, wherein the polyorganosiloxanes have a viscosity of less than 100 mPa·s at 25° C.

31. The polyorganosiloxanes according to claim 18, wherein the polyorganosiloxanes have a molecular weight (determined by gel permeation chromatography against polystyrene as standard) with a number average Mₙ of 360 to 2,000 g/mol.

32. The polyorganosiloxanes according to claim 19, wherein the polyorganosiloxanes have a molecular weight (determined by gel permeation chromatography against polystyrene as standard) with a number average Mₙ of 360 to 2,000 g/mol.

33. A hydro-mount comprising the polyorganosiloxanes according to claim 18.

34. A hydro-mount comprising the polyorganosiloxanes according to claim 19.

35. A cosmetic composition comprising the polyorganosiloxanes of formula (I) as defined in claim 18.

36. A method for preparing the polyorganosiloxanes according to claim 18, comprising:
i) reacting a compound of the formula:
M^{H}ₐD_{b}T_{c}Q_{d}
wherein M^{H}, D, T, Q signify 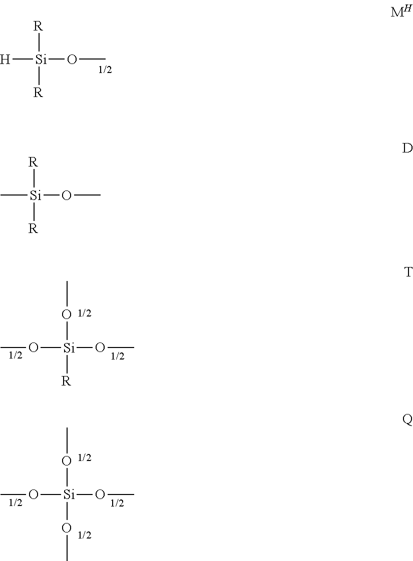
with a compound
CH₂═CHR¹—R², or
with a compound
CR³≡CR²,
in the presence of a hydrosilylation catalyst, or
(ii) reacting a compound of the formula:
M^{H}ₐD_{b}T_{c}Q_{d}
with a compound of the formula HO—R, in the presence of a catalyst, during which reaction a R—O—Si group is formed in M with hydrogen evolution,
or
iii) hydrolysis or alcoholysis of at least one halogen or alkoxysilane precursors of the units M, D, T, Q, which comprise at least one group R, wherein R is as defined above.

37. A method of transmitting force or heat comprising providing a hydro-mount comprising a spring body and a damping unit, wherein the damping unit comprises cavities and flow channels filled with a force-transmitting liquid comprising the polyorganosiloxanes of claim 18.
